(19) United States
(12) Patent Application Publication
(10) Pub. No.: US 2026/0341005 A1
(43) Pub. Date: Oct. 29, 2026

(54) INFORMATION PROCESSING APPARATUS

(71) Applicant: TOYOTA JIDOSHA KABUSHIKI KAISHA, Aichi-ken (JP)

(72) Inventors: Betty LE DEM, Tokyo-to (JP); Nicolas BOUGIE, Tokyo-to (JP); Quan KONG, Tokyo-to (JP); Norimasa KOBORI, Tokyo-to (JP)

(21) Appl. No.: 19/649,131

(22) Filed: Apr. 16, 2026

(30) Foreign Application Priority Data
Apr. 25, 2025 (JP) 2025-073558

(51) Int. Cl. G06V 10/776; G06V 10/764; G06V 20/70

(52) U.S. Cl. CPC G06V 10/776; G06V 10/764; G06V 20/70

(57) ABSTRACT

An information processing apparatus selects a training dataset for training a large language model. The information processing apparatus includes a controller and a memory. The controller acquires a dataset in which image data is associated with text data describing an image, and acquires a score for evaluating the consistency between the image data and the text data. When the score is greater than or equal to a threshold, the controller stores the dataset in the memory. When the score is less than the threshold, the controller executes captioning to generate text data describing the image data, and re-executes processing of acquiring a score using the text data generated by the captioning.

### CROSS-REFERENCE TO RELATED APPLICATION

This application claims priority to Japanese Patent Application No. 2025-073558 filed on Apr. 25, 2025, the entire contents of which are incorporated herein by reference.

### TECHNICAL FIELD

The present disclosure relates to an information processing apparatus.

### BACKGROUND

Multimodal large language models (LLMs) that support not only text input but also image input are becoming widespread. For example, Patent Literature (PTL) 1 discloses a system capable of outputting responses from a multimodal large language model.

### CITATION LIST

### Patent Literature

PTL 1: JP 2025-025082 A

### SUMMARY

To train large language models that support text and image input, it is necessary to prepare numerous datasets in which image data is paired with text data describing images. In this case, datasets with low consistency between text data describing images and the content of image data are not effective as training data. Therefore, it is desirable to easily select datasets with high consistency between text data describing images and the content of image data.

It would be helpful to easily select datasets with high consistency between text data describing images and the content of image data.

An information processing apparatus according to the present disclosure is configured to select a training dataset for training a large language model, the information processing apparatus including:
a controller; and
a memory,
wherein the controller is configured to:
   acquire a dataset in which image data is associated with text data describing an image;
   acquire a score for evaluating the consistency between the image data and the text data;
   when the score is greater than or equal to a threshold, store the dataset in the memory; and
   when the score is less than the threshold, execute captioning to generate text data describing the image data, and re-execute processing of acquiring a score using the text data generated by the captioning.

According to the present disclosure, it is possible to easily select datasets with high consistency between text data describing images and the content of image data.

### BRIEF DESCRIPTION OF THE DRAWINGS

In the accompanying drawings:

FIG. 1 is a diagram illustrating a configuration of an information processing system according to an embodiment of the present disclosure; and

FIG. 2 is a flowchart illustrating operations of the information processing system according to the embodiment of the present disclosure.

### DETAILED DESCRIPTION

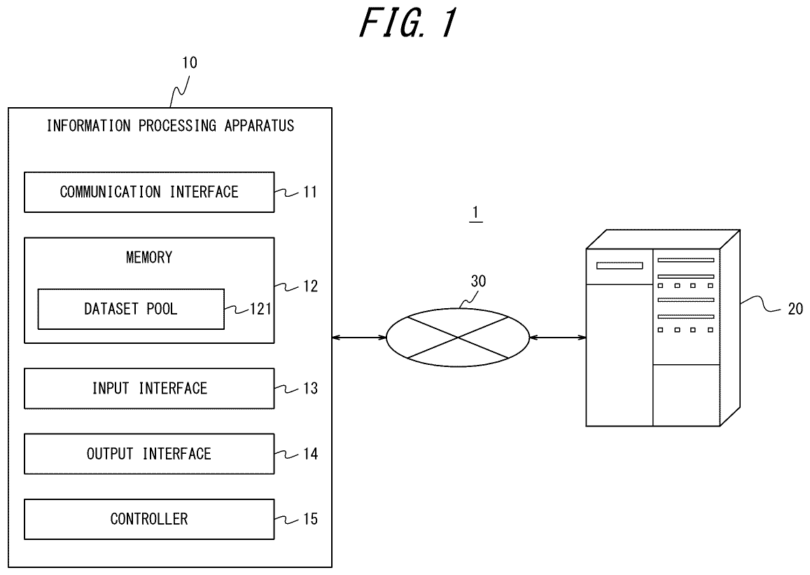

An embodiment of the present disclosure will be described below with reference to the drawings. FIG. 1 is a diagram illustrating a configuration of an information processing system 1 according to the embodiment of the present disclosure. The configuration and outline of the information processing system 1 according to the embodiment of the present disclosure will be described with reference to FIG. 1.

The information processing system 1 includes an information processing apparatus 10 and a server 20. The information processing apparatus 10 and the server 20 are communicably connected via a network 30.

The information processing apparatus 10 is a device capable of selecting a training dataset for training a large language model. In this embodiment, the large language model is a multimodal large language model that supports text and image input. The information processing apparatus 10 may be a general-purpose electronic device such as a PC (Personal Computer) or a dedicated electronic device. The information processing apparatus 10 may be composed of multiple devices.

The server 20 is a device capable of calculating a score that evaluates the consistency between the image data and the text data. The score that evaluates the consistency between the image data and the text data may be in any form, but may be, for example, a CLIP (Contrastive Language-Image Pre-training) score. The server 20 may be a general-purpose electronic device such as a workstation or PC, or a dedicated electronic device. The server 20 may be composed of multiple devices.

An outline of the present embodiment will be first described, and details thereof will be described later.

The information processing apparatus 10 acquires a dataset that associates text data describing an image with image data. The information processing apparatus 10 may acquire a dataset that associates text data describing an image with image data by collecting image data and alt text from various websites. Alt text is text that serves as a substitute for an image on a website and is text data describing an image. The information processing apparatus 10 may also acquire a dataset that associates text data describing an image with image data from other databases. Hereafter, the term “text data describing an image” may simply be referred to as “text data.”

When the information processing apparatus 10 acquires a dataset that associates image data and text data, it obtains a score that evaluates the consistency between the image data and the text data. The score that evaluates the consistency between the image data and the text data may be, for example, a CLIP score. Hereafter, the term “dataset that associates image data and text data” may simply be referred to as “dataset.”

The information processing apparatus 10 may send the image data and text data to the server 20 to have the server 20 calculate the CLIP score. In this case, the information processing apparatus 10 acquires the CLIP score calculated by the server 20 from the server 20.

When the CLIP score of the information processing apparatus 10 is greater than or equal to the threshold, it stores the dataset associating image data and text data in the dataset pool 121 of the memory 12 of the information processing apparatus 10. When the CLIP score of the information processing apparatus 10 is less than the threshold, it executes captioning to generate text data describing the image data, and re-executes the process to acquire the CLIP score using the text data generated by the captioning. Details of the captioning will be described later.

As illustrated in FIG. 1, the information processing apparatus 10 includes a communication interface 11, a memory 12, an input interface 13, an output interface 14, and a controller 15.

The communication interface 11 includes at least one external communication interface. The interface for communication may be either a wired or wireless communication interface. In the case of wired communication, the communication interface is, for example, a Local Area Network (LAN). In the case of wireless communication, the communication interface is, for example, an interface compatible with mobile communication standards such as 5G. The communication interface 11 receives data to be used in the operations of the information processing apparatus 10, and transmits data obtained by the operations of the information processing apparatus 10. The memory 12 includes at least one semiconductor memory, magnetic memory, or optical memory. The memory 12 functions, for example, as a main storage device or auxiliary storage device. The memory 12 stores data to be used in the operations of the information processing apparatus 10 and data obtained by the operations of the information processing apparatus 10. The memory 12 includes a dataset pool 121. The dataset pool 121 is an area for storing datasets with CLIP scores greater than or equal to the threshold. The input interface 13 includes at least one interface for input. The input interface may be, for example, a physical key, a touchscreen, an audio sensor that accepts audio input, or a camera that accepts gesture input. The input interface 13 accepts an operation for inputting data to be used for the operations of the information processing apparatus 10. The output interface 14 includes at least one interface for output. The output interface is, for example, a display for outputting information in the form of images, or a speaker for outputting information in the form of audio. The controller 15 includes at least one processor. The processor is, for example, a general purpose processor such as a central processing unit (CPU), or a dedicated processor specialized for specific processing.

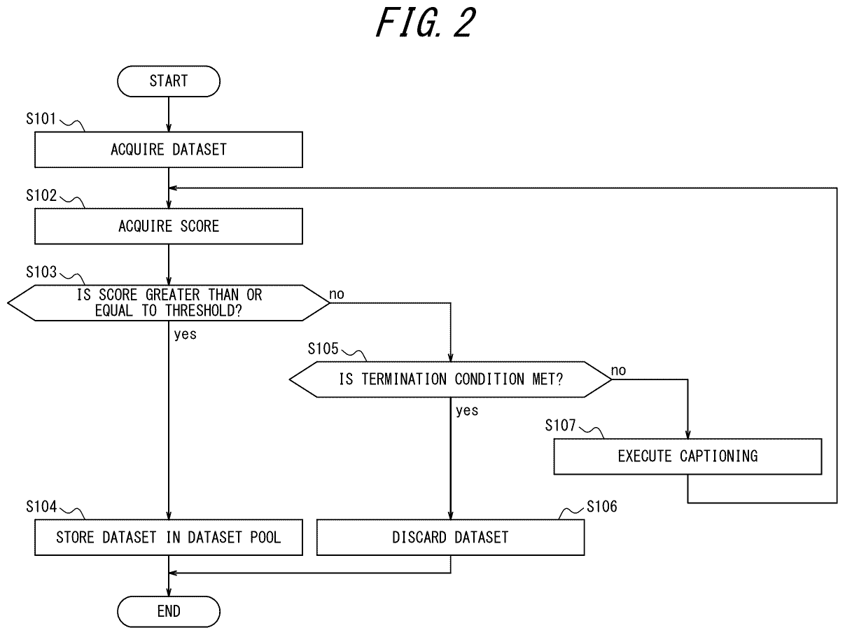

Operations of the information processing system 1 are described with reference to the flowchart in FIG. 2.

S101: The controller 15 of the information processing apparatus 10 acquires a dataset associating text data describing an image with image data.

S102: When controller 15 acquires a dataset that associates image data and text data, it obtains a score that evaluates the consistency between the image data and the text data. The score that evaluates the consistency between the image data and the text data may be, for example, a CLIP score. Hereinafter, in the present embodiment, an example will be explained in which the score that evaluates the consistency between the image data and the text data is the CLIP score.

Controller 15 sends the image data and text data to server 20 via communication interface 11 to have server 20 calculate the CLIP score. Controller 15 acquires the CLIP score calculated by server 20 via communication interface 11. Instead of server 20, controller 15 may calculate the CLIP score.

The image data may include data of the entire image as well as instance data. An instance may be something included in the image, such as “person,” “dog,” or “car.” The text data includes at least one of captions and categories. A caption is a description of the entire image data or instance data in text form. For example, it is a sentence like “The dog is playing with a ball.” A category is the type of the entire image data or instance data. For example, it could be “dog,” “ball,” etc.

If the image data includes both the entire image data and instance data, and the text data includes captions and categories, controller 15 may obtain the following four scores.
The first score that evaluates the consistency between the entire image data and the entire image caption.
The second score that evaluates the consistency between the entire image data and the entire image category.
The third score that evaluates the consistency between the instance data and the instance caption.
The fourth score that evaluates the consistency between the instance data and the instance category.

S103: Controller 15 determines whether the CLIP score is greater than or equal to the threshold. If the CLIP score is greater than or equal to the threshold, controller 15 proceeds to S104. If the CLIP score is less than the threshold, controller 15 proceeds to S105. The threshold may be a predetermined specified threshold.

For example, if there are a first score, a second score, a third score, and a fourth score, and if any of the first score, second score, third score, or fourth score is greater than or equal to the threshold, the controller 15 may proceed to S104. If all of the first score, second score, third score, and fourth score are less than the threshold, the controller 15 may proceed to S105.

S104: If the CLIP score is greater than or equal to the threshold, the controller 15 stores the dataset associating image data and text data in the dataset pool 121 of the memory 12. As a result, the controller 15 can select a dataset with high consistency between the text data describing the image and the content of the image data, and store it in the dataset pool 121 of the memory 12.

S105: The controller 15 determines whether the termination condition is met. The termination condition may be, for example, that the captioning to be executed in S107 described later has been performed a predetermined number of times, or that a predetermined time has elapsed. The predetermined number may be a number set in advance. The predetermined number may be, for example, once. The predetermined time may be a time set in advance. If the termination condition is met, the controller 15 proceeds to S106. If the termination condition is not met, the controller 15 proceeds to S107.

S106: The controller 15 discards datasets with a CLIP score less than the threshold. As a result, the controller 15 can discard datasets with low consistency between the text data describing the image and the content of the image data, so as not to store them in the dataset pool 121 of the memory 12.

S107: The controller 15 executes captioning to generate text data describing the image data. The controller 15 executes captioning in the following steps.
Step 1: The controller 15 extracts instances from the image data.
Step 2: The controller 15 generates a caption for the entire image.
Step 3: The controller 15 generates a category for the entire image.
Step 4: The controller 15 generates captions for all extracted instances.

Step 5: The controller 15 generates categories for all the extracted instances.

The controller 15 returns to S102 after executing captioning. As a result, the controller 15 can re-execute the processing of acquiring a score to be executed at S102 using the text data generated by captioning. Additionally, the controller 15 can re-execute the processing from S103 onwards.

As mentioned above, executing captioning to generate text data increases the consistency between the image data and the text data, and the CLIP score may exceed the threshold. In this case, the controller 15 can determine that the CLIP score is greater than or equal to the threshold in the processing of S103 and store the dataset in the dataset pool 121 of the memory 12.

The datasets stored in the dataset pool 121 of the memory 12 in this way can be used as training datasets for training large language models. In this case, for example, it is also possible to use the dataset with a higher CLIP score as the training dataset.

When acquiring a score at S102, the controller 15 may also acquire feedback information. Then, when executing captioning at S107, the controller 15 may adjust parameters based on the feedback information and execute captioning. The feedback information may be information indicating the cause of a low CLIP score, for example, when the CLIP score is low. For example, if the CLIP score is low due to the small size of the instance, the feedback information may include the information “the size of the instance is small.” In this case, the controller 15 may execute processing to increase the size of the instance that is considered small before executing captioning. The feedback information may be generated by the server 20, for example.

As mentioned above, in the information processing apparatus 10 according to the present embodiment, the controller 15 acquires a dataset that associates text data describing images with image data and obtains a score that evaluates the consistency between the image data and the text data. Then, if the score is greater than or equal to the threshold, the dataset is stored in the memory 12, and if the score is less than the threshold, captioning is executed to generate text data describing the image data, and the processing of acquiring a score is re-executed using the text data generated by captioning. As a result, the information processing apparatus 10 according to the present embodiment can store only datasets with scores such as the CLIP score that are greater than or equal to the threshold in the memory 12. Additionally, if the score such as the CLIP score is less than the threshold, the information processing apparatus 10 according to the present embodiment can improve the CLIP score by executing captioning. Therefore, the information processing apparatus 10 according to the present embodiment can easily select datasets with high consistency between text data describing images and the content of image data.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

For example, some of the processing operations executed in the information processing apparatus 10 in the above embodiment may be executed in the server 20. Some of the processing operations executed in the server 20 in the above embodiment may be executed in the information processing apparatus 10.

For example, the information processing apparatus 10 may acquire video data instead of image data. In this case, the information processing apparatus 10 may extract at least one frame from the multiple frames contained in the video data as image data, and may execute the processing described in the above embodiment for the extracted image data.

For example, in the above embodiment, it was explained using the case of storing a dataset in the dataset pool 121 of the memory 12, but a dataset may also be stored in a device other than the information processing apparatus 10.

1. An information processing apparatus configured to select a training dataset for training a large language model, the information processing apparatus comprising:
a controller; and
a memory,
wherein the controller is configured to:
acquire a dataset in which image data is associated with text data describing an image;
acquire a score for evaluating consistency between the image data and the text data;
when the score is greater than or equal to a threshold, store the dataset in the memory; and
when the score is less than the threshold, execute captioning to generate text data describing the image data, and re-execute processing of acquiring a score using the text data generated by the captioning.

2. The information processing apparatus according to claim 1, wherein the text data includes a caption and/or a category.

3. The information processing apparatus according to claim 1, wherein when executing the captioning, the controller is configured to:
extract an instance from the image data;
generate a caption and a category for the entire image of the image data; and
generate a caption and a category for the instance.

4. The information processing apparatus according to claim 1, wherein when the image data includes data for the entire image and data for an instance, and the text data includes captions and categories, the controller is configured to:
acquire a first score for evaluating consistency between the data for the entire image and a caption for the entire image;
acquire a second score for evaluating consistency between the data for the entire image and a category for the entire image;
acquire a third score for evaluating consistency between the data for the instance and a caption for the instance;
acquire a fourth score for evaluating consistency between the data for the instance and a category for the instance; and
when any of the first score, the second score, the third score, or the fourth score is greater than or equal to the threshold, store the dataset in the memory, and when all of the first score, the second score, the third score, and the fourth score are less than the threshold, execute captioning and re-execute processing of acquiring a score using text data generated by the captioning.

5. The information processing apparatus according to claim 1, wherein the controller is configured to discard the dataset when the score is less than the threshold after captioning is executed a predetermined number of times, or when the score is less than the threshold after a predetermined time has elapsed.
